(19) United States
(12) Patent Application Publication
(10) Pub. No.: US 2026/0257564 A1
(43) Pub. Date: Sep. 3, 2026

(54) CONTROL OF FORCE TO BE APPLIED PER WHEEL PAIR AT A TRAILER

(71) Applicant: Volvo Truck Corporation, Göteborg (SE)

(72) Inventors: Leo Laine, GÖTEBORG (SE); Charlotte Holmen, GÖTEBORG (SE)

(21) Appl. No.: 18/875,386

(22) PCT Filed: Jun. 20, 2022
(86) PCT No.: PCT/EP2022/066743

§ 371 Date: Dec. 16, 2024

(51) Int. Cl. B60L 15/20; B60L 7/26

(52) U.S. Cl. CPC B60L 15/2018; B60L 7/26; B60L 2200/28; B60L 2240/26; B60L 2240/642

(57) ABSTRACT

Techniques for controlling a force, denoted 2F×2, to be applied per wheel pair at a trailer when the trailer is moving along a slope. The trailer comprises an electrical drive axle to which wheel pairs are coupled. The trailer has a mass, denoted m. A method comprises obtaining, from at least one sensor, an indication of the mass m of the trailer and an indication of a current inclination angle, denoted α, of the trailer with respect to a horizontal plane of Earth as the trailer is moving along the slope. The method comprises limiting the force 2F×2 to currently be applied per wheel pair at the trailer to 2F×2≤mg sin α, where g denotes Earth's gravity.

### TECHNICAL FIELD

Embodiments presented herein relate to a method, a system, and a computer program for controlling a force to be applied per wheel pair at a trailer when the trailer is moving along a slope. Embodiments presented herein further relate to a vehicle comprising such a system.

### BACKGROUND

In general terms, when using a trailer that comprises an electrical drive axle, the braking and propulsion of the trailer evidently should be coordinated with the propulsion and braking of the truck that is towing the trailer.

In this respect, conventional overrun braked motor vehicle trailers with a structure and a high permissible total weight, require a sufficiently dimensioned towing vehicle with sufficient drive power or drive energy and dead weight for towing. Towing vehicles in the form of electric or hybrid vehicles with an electric drive motor and an electric energy store can have problems with this. When used with a trailer, their range is significantly reduced, especially on uphill stretches.

Electrification of trucking will demand efficient energy buffers to maintain the productivity of diesel propelled truck-trailer combinations, especially when it comes to range capability. One aspect is to match the driver working hours. For example, during a one-day working shift, a driver might typically drive a range in the order of 800 km to 900 km. Most electric trucks will today not be able to meet this range due to energy density limitations and packaging issues. Technologies relating to electrical drive axle that remove enable removal of transmissions and drive shafts allow space instead for batteries between the front steered axle and the rear drive electrical drive axle.

Document EP 3 656 619 A1 relates to the fields of mechanical and electronic engineering, focusing on energy efficiency on freight transport systems. More specifically, the invention applies to Long Combination Vehicles (LCV), in which the semi-trailer is provided with an auxiliary traction system, such as electric traction with regenerative braking, for example. The invention provides means for controlling the actuation of the auxiliary traction, which provides safe use and enhances economic and environmental savings in freight transport. In one embodiment, the invention provides a system for managing the auxiliary traction on a road implement that provides improved, safer drivability of the set.

### SUMMARY

An object of the embodiments disclosed herein is to address the issues noted above.

When coordinating the braking and propulsion of the trailer with the propulsion and braking of the truck that is towing the trailer, the relative force between the towing truck and the trailer should be minimized. This means that the coordination should take into account the slope of the road and how this affects the force. A particular object of the embodiments disclosed herein is to address this issue.

According to a first aspect, the object is achieved by a method for controlling a force, denoted 2F×2, to be applied per wheel pair at a trailer when the trailer is moving along a slope. The trailer comprises an electrical drive axle to which wheel pairs are coupled. The trailer has a mass, denoted m. The method comprises obtaining, from at least one sensor, an indication of the mass m of the trailer and an indication of a current inclination angle, denoted α, of the trailer with respect to a horizontal plane of Earth as the trailer is moving along the slope. The method comprises limiting the force 2F×2 to currently be applied per wheel pair at the trailer to 2F×2≤mg sin α, where g denotes Earth's gravity.

According to a second aspect, the object is achieved by a system for controlling a force, denoted 2F×2, to be applied per wheel pair at a trailer when the trailer is moving along a slope. The trailer comprises an electrical drive axle to which wheel pairs are coupled. The trailer has a mass, denoted m. The system comprises processing circuitry. The processing circuitry is configured to cause the system to obtain, from at least one sensor, an indication of the mass m of the trailer and an indication of a current inclination angle, denoted α, of the trailer with respect to a horizontal plane of Earth as the trailer is moving along the slope. The processing circuitry is configured to cause the system to limit the force 2F×2 to currently be applied per wheel pair at the trailer to 2F×2≤mg sin α, where g denotes Earth's gravity.

According to a third aspect, the object is achieved by a vehicle comprising a system according the second aspect.

According to a fourth aspect, the object is achieved by a computer program for controlling a force to be applied per wheel pair at a trailer when the trailer is moving along a slope, the computer program comprising computer program code which, when run on a system, causes the system to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these techniques ensure that a trailer having an electric driving axle does not produce too much traction force or brake force in a slope.

Advantageously, these techniques enable an entire truck-trailer combination (where the truck is arranged for towing the trailer) to be controlled in a safe and efficient way.

Advantageously, these techniques enable improved range capability for a truck-trailer combination comprising such a trailer.

According to an embodiment, the force 2F×2 is further limited by c·Pₜᵣₐᵢₗₑᵣ≥2F×2, where Pₜᵣₐᵢₗₑᵣ denotes a brake demand pressure for the trailer and c is a constant that translates the brake demand pressure to a force. Hence, this embodiment provides an upper bound on the force 2F×2.

Advantageously, this assists to improve energy efficiency and improving the range capability in a safe manner without the need of different control protocol between the truck and the trailer.

According to an embodiment, the inclination angle indicates that the slope is a downhill slope, and the force is a brake force to be applied to the wheel pair for preventing the trailer from slipping downwards along the downhill slope.

According to an embodiment, the inclination angle indicates that the slope is an uphill slope, and the force is to be applied to the wheel pair for propelling the trailer upwards along the uphill slope.

According to an embodiment, the trailer comprises an electric machine, wherein each wheel pair is provided with service brakes, and the force is a sum of a brake force provided by the electric machine and the service brakes.

Further advantages and advantageous features of the inventive concept are disclosed in the following description and in the dependent claims.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a carriage standing in a downhill slope;

FIG. 2 schematically illustrates a carriage standing in an uphill slope;

FIG. 3 is a flowchart of methods according to embodiments;

FIG. 4 is a schematic illustration of a trailer according to an embodiment;

FIG. 5 is a schematic diagram showing functional units of a system according to an embodiment; and

FIG. 6 shows one example of a computer program product comprising computer readable storage medium according to an embodiment.

### DETAILED DESCRIPTION OF EXAMPLE EMBODIMENTS OF THE INVENTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The issues addressed by the present disclosure concern limitations of the braking force to be applied at a trailer travelling in, or being positioned in, a slope.

As noted above, when using a trailer that comprises an electrical drive axle, the braking and propulsion of the trailer evidently should be coordinated with the propulsion and braking of the truck that is towing the trailer. This could enable a safe, comfortable and energy efficient operation of the truck-trailer combination. The present disclosure is based on that when the truck-trailer combination is travelling in a slope, the force from the trailer should not exceed the force resulting from the slope. In this way, the slope force is at most nullified.

ISO 11992 is a Controller Area Network (CAN) based vehicle bus standard used in the heavy-duty truck industry. The ISO 11992 standard, with the full name “Road vehicles—Interchange of digital information on electrical connections between towing and towed vehicles”, is used for communication between the truck and the trailer.

According to the ISO 11992 standard, the pressure request to the trailer for service brake demands should be as in Table 1 (corresponding to Table 21 in Section 6.5.4.3 in the ISO 11992 standard):

TABLE 1
specifications of the parameter “service brake
demand pressure” according to ISO 11992.

| Attribute | Value | |
|---|---|---|
| Data length | 2 | byte |
| Resolution | 5/256 | kPa/bit |
| Offset | 0 | kPa |

| | |
|---|---|
| Data range | 0 kPa to 1 255 kPa |
| Operating range | 0 kPa to 1 255 kPa |
| Type | status |

In a note to the table is in the ISO 11992 standard specified that the value of the pressure request can be modified by the coupling force control function, which has been specified by UNECE Regulation No. 13, entitled “Uniform provisions concerning the approval of vehicles of categories M, N and O with regard to braking”, where UNECE is short for United Nations Economic Commission for Europe. The value of the brake demand pressure can thus be modified by the coupling force control function.

In general terms, the coupling force is controlled so that there is not too much push from the trailer-side, for example during downhill constant cruise speed. For the fifth wheel there is some pushing coupling force, and drawbar couplings yield a closer to zero coupling force, desired in constant cruise speed downhill. Trucks with electronic braking systems might adapt the coupling force control to the current loading conditions (masses) on the truck and the trailer. All axles in the truck-trailer combination should perform braking of their own load.

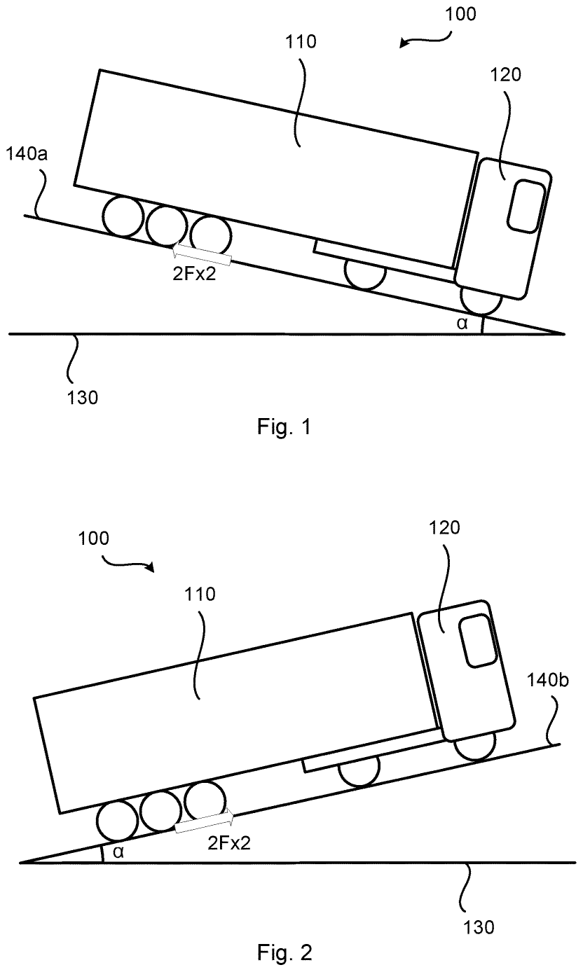

FIG. 1 and FIG. 2 schematically illustrate a carriage 100. In general terms the carriage 100 is a heavy-duty carriage comprising a towing vehicle 120 and a towed vehicle 110. In this respect, the present inventive concept is applicable to different types of heavy-duty vehicles, such as, but not limited to, towing vehicles 120 in terms of trucks, tractors, buses and construction equipment, as well as to different types of towed vehicles 110, such as trailers 110, dollys, etc. In some aspects, it is assumed that the towing vehicle 120 and the towed vehicle 110 supports the aforementioned ISO 11992 standard. Without loss of generality, the towed vehicle 110 will be exemplified by a trailer and the towing vehicle 120 will be represented by a truck.

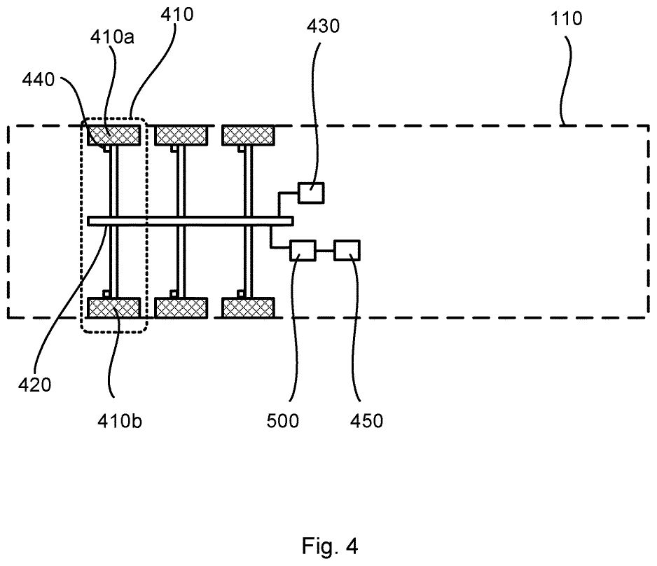

Consider first the scenario in FIG. 1 where the trailer 110 as towed by the truck 120 is to be standing still in a downhill slope 140a having an inclination angle α with respect to the horizontal plane 130 of the Earth. Thus, the total braking force per wheel pair 410 (each comprising one left wheel and one right wheel; see FIG. 4), denoted 2F×2, of the trailer 110, required for the trailer 110 to be standing still by itself (i.e., without the truck 120 exhibiting any force on the trailer 110) is:

$$2 Fx 2 \leq m g sin α$$

where m is the mass of the trailer 110 and where g denotes Earth's gravity.

When the trailer 110 is moved along the downhill slope 140a, 2F×2 will be the sum of the brake force provided by the electric machine 430 (see FIG. 4) and the service brakes (see, FIG. 4). When the truck 120 requests braking, the trailer 110 can select how much of the total force 2F×2 per wheel pair 410 should be from the electric machine 430 (and/or how much should be from the service brakes 440).

Consider now the scenario in FIG. 2 where the trailer 110 as towed by the truck 120 is to be standing still in an uphill slope 140b having an inclination angle α with respect to the horizontal plane 130 of the Earth. Thus, again, the total braking force per wheel pair 410, denoted 2F×2, of the trailer 110, required for the trailer 110 to be standing still by itself (i.e., without the truck 120 exhibiting any force on the trailer 110) is:

$$2 Fx 2 \leq m g sin α .$$

When the trailer 110 is moved along the uphill slope 140b, 2F×2 will be the force needed for not letting the trailer 110 slip downwards along the slope.

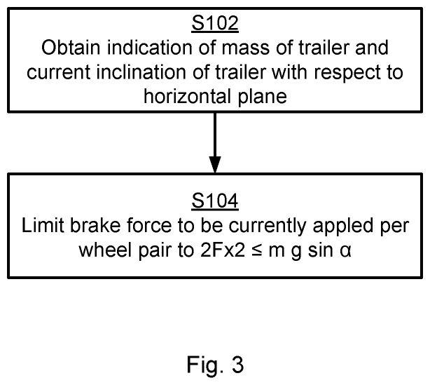

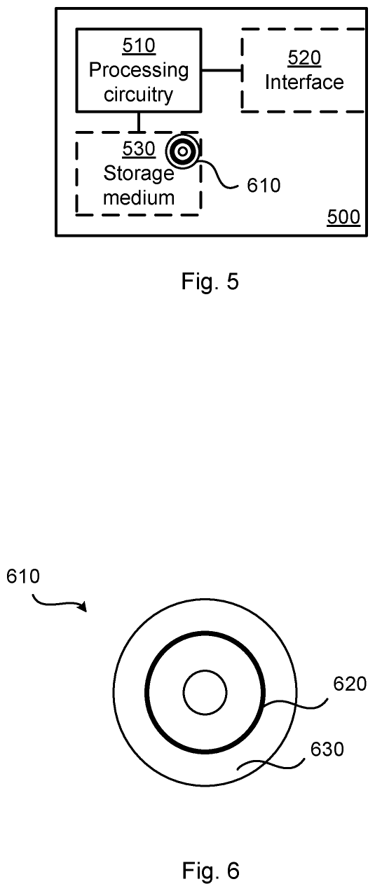

Reference is next made to FIG. 3 which is a flowchart illustrating embodiments of methods for controlling the force 2F×2 to be applied per wheel pair 410 at the trailer 110 when the trailer 110 is moving along a slope 140a, 140b. The trailer 110 comprises an electrical drive axle 420 (see, FIG. 4) to which wheel pairs 410 are coupled. The trailer 110 has a mass, denoted m. The methods are performed in a system 500 (see, FIG. 4 and FIG. 5). The methods are advantageously provided as computer programs 620 (see, FIG. 6).

The methods are based on limiting the brake force 2F×2 of the trailer 110 as a function of the mass m of the trailer 110 and an indication of a current inclination angle, denoted α, of the trailer 110. Hence, step S102 is executed.

S102: An indication of the mass m of the trailer 110 and an indication of a current inclination angle α of the trailer 110 with respect to the horizontal plane 130 of the Earth are obtained from at least one sensor 450 (see, FIG. 4) as the trailer 110 is moving along the slope. The at least one sensor 450 is therefore configured and arranged to provide the road angle (i.e., the inclination angle α) and the input to the mass estimation of the trailer 110. The at least one sensor 450 might be any, or any combination, of: an inertial measurement unit, an accelerometer, a gyro. Further, the sensor 450 might be represented by a global positioning system with map data comprising slope information.

The brake force 2F×2 of the trailer 110 should be set to not be larger than the force that is accelerating the trailer 110 due to the slope, namely 2F×2<mg sin α. Hence, step S104 is executed.

S104: The force 2F×2 to currently be applied per wheel pair 410 at the trailer 110 (i.e., for the current inclination angle α) is limited to:

$$2 Fx 2 \leq m g sin α ,$$

where, as above, g denotes Earth's gravity.

Embodiments relating to further details of controlling the force 2F×2 to be applied per wheel pair 410 at a trailer 110 when the trailer 110 is moving along a slope will now be disclosed.

In some examples the force 2F×2 is further upwards limited by:

$$c \cdot {P}_{trailer} \geq 2 Fx 2 ,$$

where Pₜᵣₐᵢₗₑᵣ denotes a brake demand pressure for the trailer 110 and c is a constant that translates the brake demand pressure to a force. This is as much the brake pressure request of braking is desired by the truck 120. To meet this value, the electric machine 430 braking on the trailer 110 should thus be below or equal to c·Pₜᵣₐᵢₗₑᵣ. If the electric machine 430 cannot carry out the whole request, the rest is achieved by adding a trailer service brake pressure to fulfil the complete demand of Pₜᵣₐᵢₗₑᵣ. This brake demand that is not handled by the electric machine 430 is executed by the service brakes of the trailer 110. With the introduction of some new labels, this can be expressed as:

$$c \cdot {P}_{trailer , s} = c \cdot {P}_{trailer , requested} - 2 F x {2}_{m}$$

where c·Pₜᵣₐᵢₗₑᵣ,s is the requested trailer demand by tractor unit, c·Pₜᵣₐᵢₗₑᵣ, requested is the actual brake demand, and 2F×2ₘ is the part of the actual brake demand that is actually carried out by the electric machine 430 (i.e., where 2F×2ₘ≤2F×2). The latter could be decided value by the trailer energy management system based on current battery condition (state-of-charge; SOC or state-of-health; SOH) and driving situation (uphill speed, or downhill speed).

In some examples, as in FIG. 1, the inclination angle α indicates that the slope is a downhill slope 140a, and the force is a brake force to be applied to each wheel pair 410 for preventing the trailer 110 from slipping downwards along the downhill slope 140a.

In some examples, as in FIG. 2, the inclination angle α indicates that the slope is an uphill slope 140b, and the force is to be applied to each wheel pair 410 for propelling the trailer 110 uphill along the uphill slope 140b.

In some examples, the trailer 110 comprises an electric machine 430, and each wheel pair 410 is provided with service brakes 440. Then, the force 2F×2 is a sum of the brake force provided by the electric machine 430 and the service brakes 440. Electric machines 430 can be directly in-wheel mounted, near wheel mounted, or use a differential to distribute equal force between the left wheel and the right wheel of a wheel axle and allow different wheel speeds during turning.

FIG. 4 schematically illustrates a top view of the trailer 110 comprising a system 500 as herein disclosed. According to the example in FIG. 4, the trailer 110 has three wheel pairs, one of which, as identified at reference numeral 410, is defined by the two wheels 410a, 410b. In the example of FIG. 4, all wheel pairs are coupled to a common electrical drive axle 420. However, alternatively, each wheel pair may have its own electrical drive axle 420. Each wheel 410a, 410b has its own service brake, one of which is identified at reference numeral 440. Further, the system 500 and the electric machine 430 are also illustrated to be coupled to the electrical drive axle 420. However, alternatively, each wheel pair, or even each wheel, may have its own electric machine. The electric machines may then be provided next to the service brakes. At least one sensor 450 as disclosed above is operatively coupled to the system 500.

FIG. 5 schematically illustrates, in terms of a number of functional units, the components of a system 500 according to an embodiment. Processing circuitry 510 is provided using any combination of one or more of a suitable central processing unit (CPU), multiprocessor, microcontroller, digital signal processor (DSP), etc., capable of executing software instructions stored in a computer program product 610 (as in FIG. 6), e.g., in the form of a storage medium 530. The processing circuitry 510 may further be provided as at least one application specific integrated circuit (ASIC), or field programmable gate array (FPGA).

Particularly, the processing circuitry 510 is configured to cause the system 500 to perform a set of operations, or steps, as disclosed above. For example, the storage medium 530 may store the set of operations, and the processing circuitry 510 may be configured to retrieve the set of operations from the storage medium 530 to cause the system 500 to perform the set of operations. The set of operations may be provided as a set of executable instructions.

Thus, the processing circuitry 510 is thereby arranged to execute methods as herein disclosed. The storage medium 530 may also comprise persistent storage, which, for example, can be any single one or combination of magnetic memory, optical memory, solid state memory or even remotely mounted memory. The system 500 may further comprise an interface 520 at least configured for communications with other functions, nodes, and devices. The processing circuitry 510 controls the general operation of the system 500 e.g., by sending data and control signals to the interface 520 and the storage medium 530, by receiving data and reports from the interface 520, and by retrieving data and instructions from the storage medium 530. Other components, as well as the related functionality, of the system 500 are omitted in order not to obscure the concepts presented herein.

FIG. 6 shows one example of a computer program product 610 comprising computer readable storage medium 630. On this computer readable storage medium 630, a computer program 620 can be stored, which computer program 620 can cause the processing circuitry 510 and thereto operatively coupled entities and devices, such as the interface 520 and the storage medium 530, to execute methods according to embodiments described herein. The computer program 620 and/or computer program product 610 may thus provide means for performing any steps as herein disclosed.

In the example of FIG. 6, the computer program product 610 is illustrated as an optical disc, such as a CD (compact disc) or a DVD (digital versatile disc) or a Blu-Ray disc. The computer program product 610 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 620 is here schematically shown as a track on the depicted optical disk, the computer program 620 can be stored in any way which is suitable for the computer program product 610.

It is to be understood that the present invention is not limited to the embodiments described above and illustrated in the drawings; rather, the skilled person will recognise that many changes and modifications may be made within the scope of the appended claims.

1. A method for controlling a force, 2F×2, to be applied per wheel pair at a trailer when the trailer is moving along a slope, the trailer comprising an electrical drive axle to which wheel pairs are coupled, the trailer having a mass, m, the method comprising:
obtaining, from at least one sensor, an indication of the mass, m, of the trailer and an indication of a current inclination angle, α, of the trailer with respect to a horizontal plane of Earth as the trailer is moving along the slope; and
limiting the force 2F×2 to currently be applied per wheel pair at the trailer to:
$$2 Fx 2 \leq m g sin α ,$$
where g denotes Earth's gravity.

2. The method of claim 1, wherein the force 2F×2 is further limited by:
$$c \cdot {P}_{trailer ( 110 )} \geq 2 Fx 2 ,$$
where Pₜᵣₐᵢₗₑᵣ denotes a brake demand pressure for the trailer and c is a constant that translates the brake demand pressure to a force.

3. The method of claim 1, wherein the inclination angle, α, indicates that the slope is a downhill slope, and wherein the force is a brake force to be applied to the wheel pair for preventing the trailer from slipping downwards along the downhill slope.

4. The method of claim 1, wherein the inclination angle, α, indicates that the slope is an uphill slope, and wherein the force is to be applied to the wheel pair for propelling the trailer uphill along the uphill slope.

5. The method of claim 1, wherein the trailer comprises an electric machine, wherein each wheel pair is provided with service brakes, and wherein the force 2F×2 is a sum of a brake force provided by the electric machine and the service brakes.

6. A system for controlling a force, 2F×2, to be applied per wheel pair at a trailer when the trailer is moving along a slope, the trailer comprising an electrical drive axle to which wheel pairs are coupled, the trailer having a mass, m, the system comprising processing circuitry, the processing circuitry being configured to cause the system to:
obtain, from at least one sensor, an indication of the mass, m, of the trailer and an indication of a current inclination angle, α, of the trailer with respect to a horizontal plane of Earth as the trailer is moving along the slope; and
limit the force 2F×2 to currently be applied per wheel pair at the trailer to:
$$2 Fx 2 \leq m g sin α ,$$
where g denotes Earth's gravity.

7. The system of claim 6, wherein the force 2F×2 is further limited by:
$$c \cdot {P}_{trailer ( 110 )} \geq 2 Fx 2 ,$$
where P_{trailer (110)} denotes a brake demand pressure for the trailer and c is a constant that translates the brake demand pressure to a force.

8. The system of claim 6, wherein the inclination angle, α, indicates that the slope is a downhill slope, and wherein the force is a brake force to be applied to the wheel pair for preventing the trailer from slipping downwards along the downhill slope.

9. The system of claim 6, wherein the inclination angle, α, indicates that the slope is an uphill slope, and wherein the force is to be applied to the wheel pair for propelling the trailer uphill along the uphill slope.

10. The system of claim 6, wherein the trailer comprises an electric machine, wherein each wheel pair is provided with service brakes, and wherein the force 2F×2 is a sum of a brake force provided by the electric machine and the service brakes.

11. A vehicle comprising the system of claim 6.

12. A computer program for controlling a force, 2F×2, to be applied per wheel pair at a trailer when the trailer is moving along a slope, the trailer comprising an electrical drive axle to which wheel pairs are coupled, the trailer having a mass, m, the computer program comprising computer code which, when run on processing circuitry of a system, causes the system to:
obtain, from at least one sensor, an indication of the mass, m, of the trailer and an indication of a current inclination angle, α, of the trailer with respect to a horizontal plane of Earth as the trailer is moving along the slope; and
limit the force 2F×2 to currently be applied per wheel pair at the trailer to:
$$2 Fx 2 \leq m g sin α ,$$
where g denotes Earth's gravity.

13. A computer program product comprising computer program of claim 12, and a computer readable storage medium on which the computer program is stored.
